(19) United States
(12) Patent Application Publication
(10) Pub. No.: US 2007/0052541 A1
(43) Pub. Date: Mar. 8, 2007

(54) System for detecting a local utilizaiton state of a technical system

(75) Inventors: Bernd Opgenoorth, Numberg (DE); Joachim Scharnagl, Furth (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT

(21) Appl. No.: 11/516,908

(22) Filed: Sep. 7, 2006

(30) Foreign Application Priority Data
Sep. 7, 2005 (DE) 102005042532.1

(51) Int. Cl. G08B 13/14

(52) U.S. Cl. 340/572.1

(57) ABSTRACT

The invention relates to a system for the detection of a local utilization state of a technical system for transporting and/or packaging of objects. The objects have a device for identification, especially an RFID tag, and the device for identification has a data memory. The system also has a read-write unit for the contactless reading of a data memory of an object. The system enables an early reporting of a utilization state of the technical system, such as a congestion or shortage of objects using the devices for identification. The system can also be used for object tracking. The detection of the local utilization state is realized by the repeated reading of the data memory of an object. A control unit of the system and a method for detecting a utilization state of a technical system for transporting and/or packaging objects are also provided.

### CROSS REFERENCE TO RELATED APPLICATIONS

This application claims priority of German application No. 102005042532.1 filed Sep. 07, 2005, which is incorporated by reference herein in its entirety.

### FIELD OF INVENTION

The invention relates to a system for detecting a local utilization state of a technical system for transporting and/or packaging objects, with the objects having a device for identification, especially an RFID tag, the device for identification having a data memory, the system having at least one read-write unit for the contactless reading of at least one data memory of an object. The invention also relates to a read-write unit in accordance with the preamble of and independent claim, and a method in accordance with the preamble of another independent claim.

### BACKGROUND OF THE INVENTION

Such a system, read-write unit or method is used with automated systems, product or delivery systems, or packaging lines or similar technical systems. To guarantee smooth production or packaging using complex automation and production facilities, various systems are known for the detection of utilization states, such as a congestion or shortage of products or objects. The aim of these systems is to avoid the idle time or downtime that occurs due to congestion or shortages of products, or of the objects to be transported. The technical cost and the manpower costs for detecting and rectifying the disturbances caused by the utilization states is generally very high, and the utilization states usually have the effect of impeding production. Generally, various types of sensors can be used to monitor the utilization states. These are, for example, sensors that operate on an optical or radio basis and can be universally used. Sensors that operate on an optical basis are, for example, realized by bar code scanners.

Radio-based sensors, for example, use RFID technology (radio frequency identification). Widespread use is also made of optical sensors as light barriers that usually do not require a label in the sense of the RFID tag.

RFID is a very reliable technology that is able to track objects that are largely static or moving, but in the past the high cost and inefficient process control made RFID uneconomical. RFID tags or read-write units can now be inexpensively manufactured. By means of RFID it is possible to guarantee that electronic labels can be read even under production or packaging conditions that are sometimes poor. Furthermore, it is not necessary to have an optical link to the object. It is very easily possible to shield the object if necessary and still read the RFID tag. This is a clear advantage of the RFID technology compared with optical reading methods, because in this way it is also possible to process objects that do not permit labeling in the conventional sense, or where environmental conditions do not permit labeling on the outer cover of the transported object.

Systems for detecting the utilization state of technical systems usually have a visualization of the existing circuit diagram that provides a general view of the complete system. With the increasing automation and complexity of such production lines, packaging systems or technical systems in general, the number of RFID tags to be read by the read-write unit also increases.

Frequently in the past, the machines had a technical system or a line where they are activated only be means of light barriers, i.e. the machine started if a light barrier detected an object in front of the machine. Where there are long pauses between products, for example due to a shortage, the machine continually stops and starts to process the incoming object. The same applies to the situation downstream of the machine. If the light barrier there does not signal the removal of the processed object at a certain distance from the machine within a specific time, the machine stops to prevent congestion. A superimposed operating data detection system, however, signals only the actual disturbance to the machine but not the congestion or shortage that had most probably caused it. What is worse, however, is that this causes an unwanted stop and go operation because the congestion or shortage was not detected in time and therefore an appropriate reaction was not possible. A stop and go behavior is absolutely to be avoided from the point of view of smooth production. At present it is still very difficult to reliably detect a congestion or shortage in time using simple inexpensive means.

An RFID process control system is known from US 2005 0080680 A1, that combines various components in a single unit for use in tracking systems that function with inventory objects fitted with RFID tags. The system combines an RFID controller and reader unit, process software, a computer-controlled switch and a supply management system in a single unit, with an RFID process control being realizable in conjunction with a wide spectrum of inventory tracking applications.

### SUMMARY OF INVENTION

The object of the invention is to monitor a technical system, or objects transported in the technical system, and identify utilization states in time.

This object is achieved by means of a system of the type named in the introduction in that the system by repeated reading of the data memory of at least one object a local utilization state of the technical system can be analyzed [sic]. This object is further achieved by a read-write unit and a method for detecting a local utilization state by means of the features named in certain independent claims.

Read-write units are mounted at different positions along the transport path of the objects within the technical system to optimize the use of the existing devices for identification, especially RFID tags, of the objects for detection of congestion or shortages. For this purpose, a read-write device cyclically performs a “bulk reading”. Bulk reading is the reading of several devices for identification in one read operation. If the number of identification devices detected is above a certain limit, a congestion message is output. If on the other hand the number is below a certain limit, a shortage message is output. In addition or as an alternative, a check can be carried out at each reading operation to determine whether the identities or labels of the devices read for identification are the same as in the previous read operation, or whether a high overlap is present. If this is the case, it means that the products are stationery on the conveyor and congestion must therefore have occurred or be imminent, because the rate of change is too low. In this case, also, a congestion message or warning can also be output. A shortage, or imminent shortage, is also detected by a low number of objects over a specific time period and is also reported as a shortage message or shortage warning.

Furthermore, two read-write units can be used to identify the same object at different times at various positions within the technical system using various readings taken at staggered times, to thus determine the time taken to travel the path between the two read-write units. In this respect, it is useful to use a data processing unit that processes the status data of both read-write units and enables a comprehensive analysis of the technical system. By means of the detailed information or the diagnostic data generated by the data processing unit, it is possible to appropriately optimize the traffic on the conveyor for the analysis and resolution of undesirable utilization states.

In addition to system fault and production states (machine or line produces without faults), utilization states such as congestion warning or shortage warning can be entered in a production data acquisition system. This enables a more efficient monitoring of the production, manufacturing or packaging machine line using simple means of utilizing the devices used for other purposes (product tracking or logistics support) for identification (RFID tags). Thus this provides the basis for appropriate automatic optimization for the avoidance or resolution of congestion and increasing the efficiency of production, manufacturing or packaging machines.

An advantageous form of embodiment of the system for the detection of a local utilization state of a technical system for the transport and/or packaging of objects is a system that includes a first read-write unit for initial reading of the data memory of at least one object and at least a second read-write unit for a repeat reading of the data memory. By this means, the tracking of an object within the technical system or along the transportation path of the object is guaranteed, during which process additional data on the transportation duration between the read-write units can be obtained.

In a further advantageous embodiment, the first read-write unit and the second read-write unit are provided at various positions on the transportation path of the object for reading the data memory of the object. Using the transportation between the first read-write unit and the second read-write unit, it is possible to detect a congestion or shortage.

In a further advantageous embodiment, a first local utilization state is a local congestion and a second local utilization state is a local shortage in the transportation of the objects, whereby other utilization states can be defined as a function of the technical conditions or other circumstances.

Furthermore, it is advantageous if the write-read unit is provided for simultaneously reading data memories of objects that are in the detection area of the particular read-write unit, in order to determine how many, and which, objects are in the detection area. In this way, a congestion or shortage can be determined locally at a read-write unit by the repeated reading of the data memories of the objects. A repeated detection of the same objects means in this case a congestion. If too few objects are detected this indicates a shortage.

Advantageously, a data processing unit is used to display and/or process the status data of the read-write unit. The display of the status data of the read-write unit, or of the read-write units, can usefully be used for the manual rectification of the utilization state. Furthermore, the processing by the data processing unit affords the opportunity of further using the status data for automatic rectification.

The generation of diagnostic data by the data processing unit for the control of the technical system is also advantageous, with a feedback from the system for detection of a local utilization state being used as a diagnostic system and for control units. Therefore, it is possible to achieve the best possible control of the production or packaging line or technical system as a function of the utilization state and to optimize the utilization state.

In a further advantageous form of embodiment, the system provides for detection of a utilization state of the complete technical system or part areas of the technical system. In this way, it is possible to deal with several problem zones on the transportation path at the same time using an overall concept. In particular, it is possible to avoid a stop-go behavior, which is very obstructive with regard to optimum operation.

In a further advantageous embodiment, the read-write unit provides for the storage of status data and/or diagnostic data of the data processing unit on the data memory of at least one object. This feature is shown to be advantageous if the properties of the object are relevant for the duration required by the object to be transported through the technical system or parts thereof. For example, in a paint shop an object can be painted within the technical system and be dried during the onward transportation. Before the next step can be carried out within the process, the object must be dry. If the paint is still wet, the quality of the object would be impaired. By detecting the object at two different points within the transportation path using two different read-write units, it is possible to determine the duration of the drying period. In this way, a decision can be made as to whether the object is suitable for the next processing step.

This type of process time monitoring can also be used in other applications. For example, the monitoring or detection of a time overshoot is important in the pharmaceutical or foodstuffs area because certain products may remain in a certain processing state for only a specific time period.

Advantageously, the system could include a write-read unit designed as a control unit, with the control unit also having a data processing unit in addition to the read-write unit, in order to realize a mobile system. This mobile system can be flexibly used within any technical system and especially can be used for a quite specific problem, i.e. a quite specific position can be chosen for use of this system within the transportation path.

Further advantageous embodiments and preferred developments of the invention are given in the description of the illustrations and/or in the subclaims.

The invention is described in more detail in the following with the aid of exemplary embodiments shown in the illustrations. These are as follows:

### BRIEF DESCRIPTION OF THE DRAWINGS

FIG. 1 An illustration showing the principle of a first exemplary embodiment of a system for detecting a local utilization state of a technical system.

FIG. 2 An illustration showing the principle of a second exemplary embodiment of a system for detecting a local utilization state of a technical system.

FIG. 3 A further illustration showing the principle of the second exemplary embodiment.

### DETAILED DESCRIPTION OF INVENTION

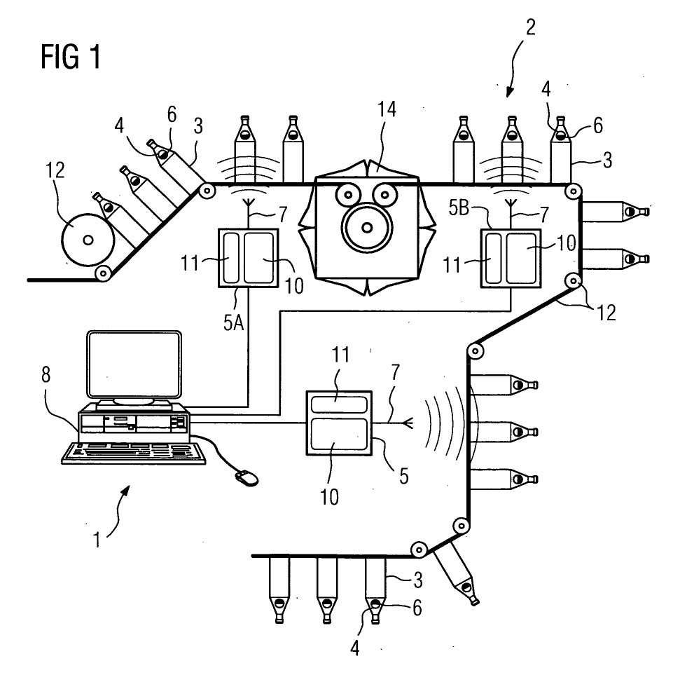

FIG. 1 is an illustration showing the principle of a first exemplary embodiment of a system 1 for detection of a local utilization state of a technical system 2. In the first exemplary embodiment the technical system 2 consists essentially of a conveyor system that transports the objects 3. Furthermore, the technical system 2 also contains conveyor system elements 12, such as machines, running wheels, conveyor belts or similar. These objects have a device 4 for identifying the objects and furthermore have a data memory 6. The objects 3 in both exemplary embodiments are given the shape of a bottle only as an example; the objects can be quite general products or all possible types of technical or non-technical objects. The purpose of the technical system 2 is to at least transport the object 3 and/or to do this in work steps in any automatically determined manner. The system 1 for detection of a local utilization state consists in the first exemplary embodiment of a data processing unit 8, and three read-write units 5, 5a, 5b positioned at defined positions along the transportation path of the object 3. The read-write units 5, 5a, 5b contain a read-unit 11, a write unit 10 and an antenna 7. A clockwise direction of conveyance is assumed in the following description. An object 3 will accordingly first pass the detection area of the read-write unit 5a, then the detection are of the read-write unit 5b and finally the detection area of the read-write unit 5. By the reading of the data memory 6 of an object 3 by the read-write unit 5a, a time point at which the object 3 passes the detection area of the read-write unit 5a is determined at the same time. The object 3 then passes the machine 14 in which it is subjected to a technical handling. It is possibly important to know how long the object 3 has been handled by the machine 14. Consequently, the time point at which the object 3 passes the detection area of the read-write unit 5b is also important, because this enables the time point at which the object 3 has left the influence area of the machine 14 to be determined. Thus, the duration of the processing of the object 3 by the machine 14 can be calculated. Information on the quality of the processing or of the object 3 itself can thus be gained from this. Furthermore, it is possible to detect a congestion in the machine 14. A congestion is present if the time since the first detection of the object 3 by the read-write unit 5a exceeds a presettable maximum value. The detection analysis can be realized in the data processing unit 8 and the representation of this congestion can, for example, be shown on a screen. A similar method can be used to detect shortages in the sense of a low occurrence of objects at a local section of the transportation path.

A through-time tracking is then particularly useful if a fault within a machine 14 or a transport section cannot be directly detected or analyzed. For example, this is the case if a machine 14 is not designed to signal a utilization state, a disturbance or a fault. It is frequently the case that the machine 14 has no diagnostic capability or is not designed to record measured values in order to determine a utilization state. The machine 14 could not also be interlinked and is thus not message-capable. If on the other hand there is a through-time tracking on the transportation path at which the machine 14 is installed, the conveyor system elements 12 and/or the machine 14 are monitored by the through-time tracking.

It is furthermore possible to simultaneously analyze and eliminate several local utilization states along the transportation path within the technical system 2.

By suitable positioning of the read-write units, the early identification of important information on the utilization state is likewise possible and this information can be immediately used for the manual or automatic rectification of the utilization state. Furthermore, constant optimization at high transport speed of the object can be used to obtain the desired utilization state without object densities that impede the process.

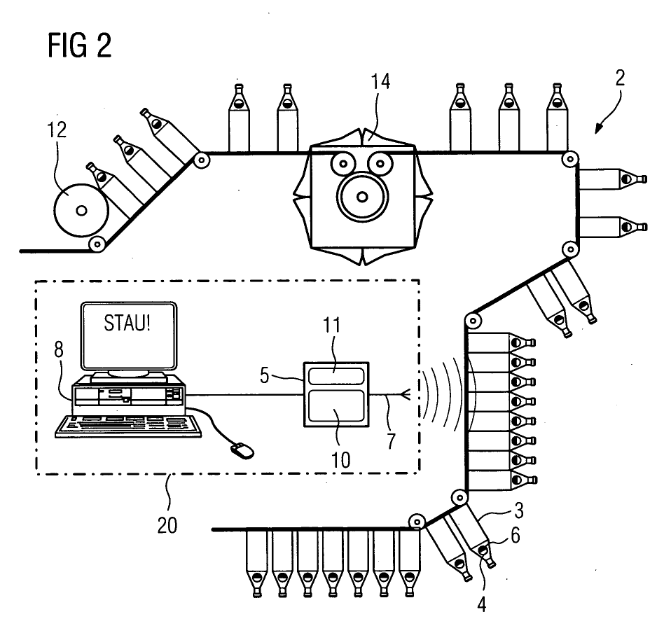

FIG. 2 is an illustration showing the principle of a further exemplary embodiment of a system 1 for detecting the local utilization state of a technical system 2. In this exemplary embodiment, the system 1 consists of a control unit 20 for detecting a utilization state of a technical system 2 that has a read-write unit 5 and a data processing unit 8. The illustrated read-write unit 5 is provided to perform a local utilization state analysis. In this case, the utilization status of a congestion of the objects 3 is present. Several objects that can be identified by bulk reading are located on the production line in the detection area of the read-write unit 5. In this way the number of objects 3 within the detection area can be determined. If this read number is below the preset threshold value for a congestion, it is assumed that no congestion is present. If this threshold value is exceeded, a congestion is present and is detected and reported. In the exemplary embodiment, the report can be sent to the data processing unit 8 or be in the form of an acoustic and/or optical signal, a warning light and/or warning signal. Assuming that this threshold value in our exemplary embodiment is present for three individual objects 3, then because there are more than six bottles in the detection area a congestion message is output. By using the unique data of the data memory 6 of the object 3, an additional check can be carried out to determine whether the objects 3 in the detection area change continuously. If this is not the case, this means that the data memory information, particularly the identification of the objects 3, remains constant over a certain time period and a large overlap of the previously read information results. Consequently, a standstill or congestion can be detected by using this method. The same applies for an object shortage. In this case a corresponding message can be output.

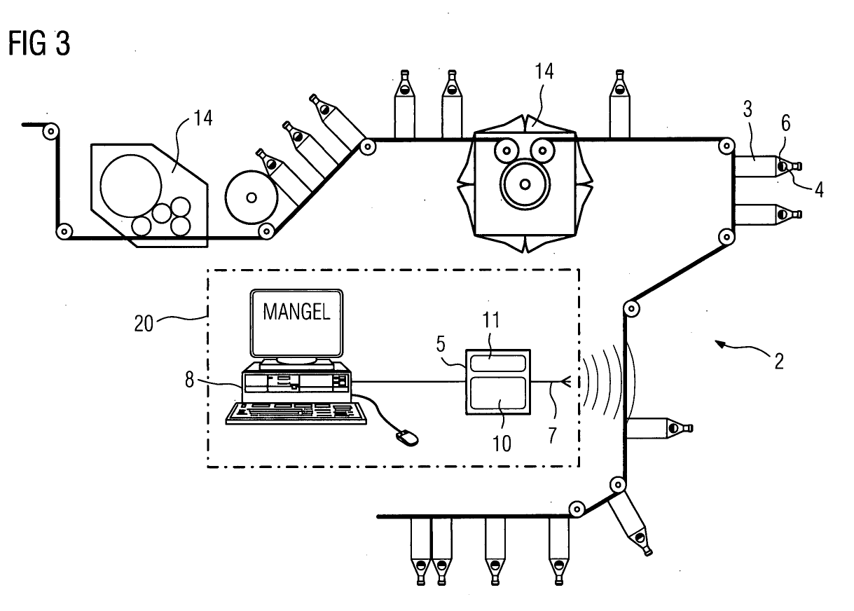

FIG. 3 is a further illustration showing the principle of the second exemplary embodiment from FIG. 2, with of course the local shortage utilization state being present. If over a longer time period, that can be specified by the user, two few data memories 6 are read, a shortage is present or is imminent. The considerations from the description of FIG. 2 are to be applied accordingly for FIG. 3. Based on the detailed information, that can be used for other purposes such as product tracking or logistic support of existing data memories 6, an exact efficiency analysis and corresponding efficiency optimization of the line or technical system is possible.

To sum up, the invention relates to a system for the detection of a local utilization state of a technical system for the transportation and/or packaging of objects, with the objects having a device for identification, especially an RFID tag, the device for identification having a data memory and the system having at least one read-write unit for the contactless reading of at least one data memory of an object. The system facilitates an early signaling of a utilization state of the technical system, such as a congestion or shortage of objects, using the devices for identification, that can also be used for object tracking. The detection of the local utilization state is realized by the repeated reading of the data memory of at least one object.

1-25. (canceled)

26. A system for detecting a local utilization state of a technical system for the transporting of objects, with the objects having a device for identification having a data memory, the system comprising:
a read-write unit comprising,
means for contactless repeated reading of the data memory of an object, and
means for analyzing a local utilization state of the technical system based on the reading of the data memory of the object.

27. The system according to claim 26, wherein the identification device comprises an RFID tag.

28. The system according to claim 26, further comprising:
a first read-write unit having means for the initial reading of the data memory of the object, and
a second read-write unit having means for the repeated reading of the data memory of the object.

29. The system according to claim 27, wherein the first read-write unit is configured to be positioned at a first position on the transportation path of the object, and the second read-write unit is configured to be positioned at a second position, remote from the first position, for reading the data memory of the object at the second position on the transportation path of the object.

30. The system according to claim 26, wherein the analyzing means further comprises, means for analyzing differing local utilization states of the technical system, wherein a first local utilization state is local congestion and a second local utilization state is a local shortage during the transportation of the objects.

31. The system according to claim 26, wherein the read-write unit reading means further comprises, means for simultaneous reading data memories of objects located within a detection area of the reading means.

32. The system according to claim 31, further comprising a plurality of read-write units, wherein each read-write unit reading means has a detection area, and the read-write unit reading means comprises means for simultaneous reading data memories of a plurality of objects located within a detection area.

33. The system according to claim 26, further comprising a data processing unit for the presentation of status data of the read-write unit.

34. The system according to claim 26, further comprising a data processing unit for the processing of status data of the read-write unit.

35. The system according to claim 34, the data processing unit further comprising means for the generation of diagnostic data for the control of the technical system.

36. The system according to claim 29, the system further comprising means for detection of a utilization state of the complete technical system or predetermined areas of the technical system.

37. The system according to claim 26, wherein the read-write unit is configured as a control unit.

38. A control unit for the detection of a local utilization state of a technical system for the transporting of objects, the objects having a device for identification having a data memory, the control unit comprising:
a read-write unit, comprising:
means for the repeated contactless reading of a data memory of an object, and
means for analyzing a local utilization state of the technical system based on the repeated reading of the data memory.

39. A control unit according to claim 38, wherein the device identification of the objects comprises RFID tags.

40. A control unit according to claim 38, wherein the analyzing means further comprises means for analyzing differing local utilization states, and wherein a first local utilization state is a local congestion and a second local utilization state is a local shortage during the transportation of the objects.

41. A control unit according to claim 38, wherein the read-write unit further comprises means for simultaneous reading data memories of objects located within a detection area of the reading means.

42. A control unit according to claim 41, further comprising a plurality of read-write units, wherein the read-write units reading means has a detection area for each read-write units, and the read-write unit reading means comprises means for simultaneous reading data memories of objects located with a detection area.

43. A control unit according to claim 38, further comprising, a data processing unit for displaying of status data of the read-write unit.

44. A control unit according to claim 42, further comprising, a data processing unit for displaying status data of the plurality of read-write units.

45. A method for the detection of a local utilization state of a technical system for transporting objects wherein the objects are configured with a device for identification RFID tag having a data memory, the method comprising:
contactlessly first reading a data memory of an object with a read-write unit,
contactlessly rereading a data memory of the object with the read-write unit a predetermined number of times; and
analyzing a local utilization state of the technical system based on the repeated reading of the data memory.

46. The method according to claim 45, wherein the data memory reading steps comprises reading a data memory of an object with a first read-write unit, and the rereading step comprises rereading the data memory of the object with a second read-write unit.

47. The method according to claim 46, wherein the first reading of the object step with the first read-write unit and the second rereading of the object step with the second read-write unit occur at different positions on the transportation path of the objects.

48. The method according to claim 45, wherein the analyzing step comprises analyzing differing local utilization states, wherein a first local utilization state is a local congestion and a second local utilization state is a local shortage during the transportation of the objects.

49. The method according to claim 45, wherein the reading step and the rereading step comprise simultaneously reading the data memories of objects located in the detection area of a particular read-write unit.
